(19) United States
(12) Patent Application Publication
(10) Pub. No.: US 2024/0378471 A1
(43) Pub. Date: Nov. 14, 2024

(54) TECHNIQUES FOR DATA POLICY ENFORCEMENT IN CLOUD COMPUTING ENVIRONMENTS

(71) Applicant: Stratyfy Inc., New York, NY (US)

(72) Inventors: Dmitry LESNIK, Tel Aviv (IL); Stas CHERKASSKY, Haifa (IL); Laura KORNHAUSER, New York, NY (US); Michael CHERKASSKY, New York, NY (US); Tobias SCHÄFER, New York, NY (US)

(73) Assignee: Stratyfy Inc., New York, NY (US)

(21) Appl. No.: 18/781,182

(22) Filed: Jul. 23, 2024

Related U.S. Application Data
(63) Continuation-in-part of application No. 16/895,667, filed on Jun. 8, 2020.
Application No. 16/895,667 is a continuation-in-part of application No. 16/644,243, filed on Mar. 4, 2020.
(60) Provisional application No. 62/554,152, filed on Sep. 5, 2017.
(60) Provisional application No. 62/858,556, filed on Jun. 7, 2019.

(51) Int. Cl. G06N 7/01; G06N 5/02; G06N 20/00

(52) U.S. Cl. CPC G06N 7/01; G06N 5/027; G06N 20/00

(57) ABSTRACT

A system and method for initiating a probabilistic rule engine (PRE) is presented. The method includes: receiving a plurality of data records, including a data input and output; assigning a weight to each of a plurality of rules implemented using a Boolean logic operator; applying each rule to each data input to generate a plurality of results, each result corresponding to a rule; generating for each data input a second output, based on the plurality of results corresponding to applying the plurality of rules on the data input; determining an objective function; generating an error value based on each output and each second output; adjusting a weight value of a first rule in response to determining that the error value is above a predetermined threshold; and processing a new data input on the PRE, in response to determining that the error value is below the predetermined threshold.

### CROSS-REFERENCE TO RELATED APPLICATIONS

This application is a continuation in part of U.S. patent application Ser. No. 16/895,667 filed Jun. 8, 2020, which claims the benefit of U.S. Provisional Application No. 62/858,556 filed on Jun. 7, 2019. The '667 application is also a continuation-in-part of U.S. patent application Ser. No. 16/644,243 filed Mar. 4, 2020. The '243 application claims priority under 35 U.S.C. § 371 to International Application No. PCT/IL2018/051103, filed Oct. 14, 2018, which in turn claims the benefit of U.S. Provisional Application No. 62/554,152 filed on Sep. 5, 2017, all contents of which are hereby incorporated by reference.

### TECHNICAL FIELD

The present disclosure relates generally to policy enforcement, and specifically to policy enforcement utilizing rule engines in a cloud computing environment.

### BACKGROUND

A rule engine is a software system that executes one or more rules in a runtime environment. Rules are typically defined as “if-then” statements, which can trigger specific actions based on given conditions. Rule engines are used to automate decision-making processes, ensuring consistent and repeatable outcomes. They are particularly effective in domains like business process management, fraud detection, and compliance checking, where predefined logic can be applied to determine actions. However, rule engines struggle with scalability and adaptability. As the number of rules increases, maintaining and updating the rule set becomes complex and error prone. Additionally, they are not well-suited for tasks requiring inference or learning from new data, limiting their flexibility in dynamic environments.

Artificial Intelligence (AI) refers to the simulation of human intelligence in machines, enabling them to perform tasks that typically require human cognition. AI encompasses a range of technologies, including machine learning, natural language processing, and computer vision. AI systems excel in recognizing patterns, making predictions, and automating complex tasks that involve large datasets, such as image and speech recognition, autonomous driving, and recommendation systems. However, a significant shortcoming of AI is its dependency on vast amounts of data for training and its potential to produce biased or unpredictable outcomes if the training data is flawed. Moreover, AI systems often function as black boxes, making it difficult to understand and interpret their decision-making processes, which can hinder trust and transparency in critical applications.

Both rule engines and AI solve different types of problems effectively. Rule engines are ideal for deterministic, rule-based scenarios requiring explicit logic, while AI excels in learning from data and handling complex, non-linear problems. However, the rigid structure of rule engines and the data dependency and opacity of AI systems highlight their respective limitations.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, method may include receiving a plurality of data records, each data record including a data input and an output. Method may also include assigning a weight value to each rule of a plurality of rules, where the rules are implemented using at least a Boolean logic operator. Method may furthermore include applying each rule of the plurality of rules to each data input of the plurality of data records to generate a plurality of results, each result corresponding to a rule of the plurality of rules. Method may in addition include generating for each data input a second output, based on the plurality of results corresponding to applying the plurality of rules on the data input. Method may moreover include determining an objective function of the probabilistic rule engine. Method may also include generating an error value based on each output of the plurality of data records and each second output. Method may furthermore include adjusting a weight value of at least a first rule in response to determining that the error value is above a predetermined threshold. Method may in addition include processing a new data input on the probabilistic rule engine, in response to determining that the error value is below the predetermined threshold. Other embodiments of this aspect include corresponding computer systems, apparatus, and computer programs recorded on one or more computer storage devices, each configured to perform the actions of the methods.

Implementations may include one or more of the following features. Method may include: adjusting the weight value in response to determining that the first rule is associated with an adjustable weight. Method may include: calibrating the probabilistic rule engine based on a first portion of the received plurality of data records. Method where calibrating the probabilistic rule engine further may include: adjusting a weight value of a rule of the plurality of rules having an adjustable weight. Method may include: testing the probabilistic rule engine based on a second portion of the received plurality of data records. Method may include: processing a data record of the second portion of the received plurality of data records to generate a second output, where the data record includes a first output; generating a difference value based on the first output and the second output; and determining that the probabilistic rule engine is initialized in response to determining that the difference value is below a threshold. Method where processing the new data input further may include: applying each rule of the plurality of rules on the new data input to generate an output. Method may include: determining that a rule of the plurality of rules is triggered in response to successfully applying the rule on the new data input. Method where a rule of the plurality of rules includes any one of: an association rule, an algebraic rule, a conditional rule, and any combination thereof. Implementations of the described techniques may include hardware, a method or process, or a computer tangible medium.

In one general aspect, non-transitory computer-readable medium may include one or more instructions that, when executed by one or more processors of a device, cause the device to: receive a plurality of data records, each data record including a data input and an output; assign a weight value to each rule of a plurality of rules, where the rules are implemented using at least a Boolean logic operator; apply each rule of the plurality of rules to each data input of the plurality of data records to generate a plurality of results, each result corresponding to a rule of the plurality of rules; generate for each data input a second output, based on the plurality of results corresponding to applying the plurality of rules on the data input; determine an objective function of the probabilistic rule engine; generate an error value based on each output of the plurality of data records and each second output; adjust a weight value of at least a first rule in response to determining that the error value is above a predetermined threshold; and process a new data input on the probabilistic rule engine, in response to determining that the error value is below the predetermined threshold. Other embodiments of this aspect include corresponding computer systems, apparatus, and computer programs recorded on one or more computer storage devices, each configured to perform the actions of the methods.

In one general aspect, system may include one or more processors configured to: receive a plurality of data records, each data record including a data input and an output. System may furthermore assign a weight value to each rule of a plurality of rules, where the rules are implemented using at least a Boolean logic operator. System may in addition apply each rule of the plurality of rules to each data input of the plurality of data records to generate a plurality of results, each result corresponding to a rule of the plurality of rules. System may moreover generate for each data input a second output, based on the plurality of results corresponding to applying the plurality of rules on the data input. System may also determine an objective function of the probabilistic rule engine. System may furthermore generate an error value based on each output of the plurality of data records and each second output. System may in addition adjust a weight value of at least a first rule in response to determining that the error value is above a predetermined threshold. System may moreover process a new data input on the probabilistic rule engine, in response to determining that the error value is below the predetermined threshold. Other embodiments of this aspect include corresponding computer systems, apparatus, and computer programs recorded on one or more computer storage devices, each configured to perform the actions of the methods.

Implementations may include one or more of the following features. System where the one or more processors are further configured to: adjust the weight value in response to determining that the first rule is associated with an adjustable weight. System where the one or more processors are further configured to: calibrate the probabilistic rule engine based on a first portion of the received plurality of data records. System where the one or more processors, when calibrating the probabilistic rule engine, are configured to: adjust a weight value of a rule of the plurality of rules having an adjustable weight. System where the one or more processors are further configured to: test the probabilistic rule engine based on a second portion of the received plurality of data records. System where the one or more processors are further configured to: process a data record of the second portion of the received plurality of data records to generate a second output, where the data record includes a first output; generate a difference value based on the first output and the second output; and determine that the probabilistic rule engine is initialized in response to determining that the difference value is below a threshold. System where the one or more processors, when processing the new data input, are configured to: apply each rule of the plurality of rules on the new data input to generate an output. System where the one or more processors are further configured to: determine that a rule of the plurality of rules is triggered in response to successfully applying the rule on the new data input. System where a rule of the plurality of rules includes any one of: an association rule, an algebraic rule, a conditional rule, and any combination thereof. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example schematic diagram of a probabilistic rule engine system, implemented in accordance with an embodiment.

FIG. 2 is an example schematic diagram of a rule engine utilizing a probabilistic rule application, utilized to describe an embodiment.

FIG. 3 is an example flowchart of a method for initializing a probabilistic rule engine, implemented in accordance with an embodiment.

FIG. 4 is an example flowchart of a method for initializing a probabilistic rule engine utilizing preexisting and generated rules, implemented in accordance with an embodiment.

FIG. 5 is an example flowchart of a method for determining an effect of a rule on an output of a probabilistic rule engine, implemented in accordance with an embodiment.

FIG. 6 is an example schematic diagram of a probabilistic rule engine according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

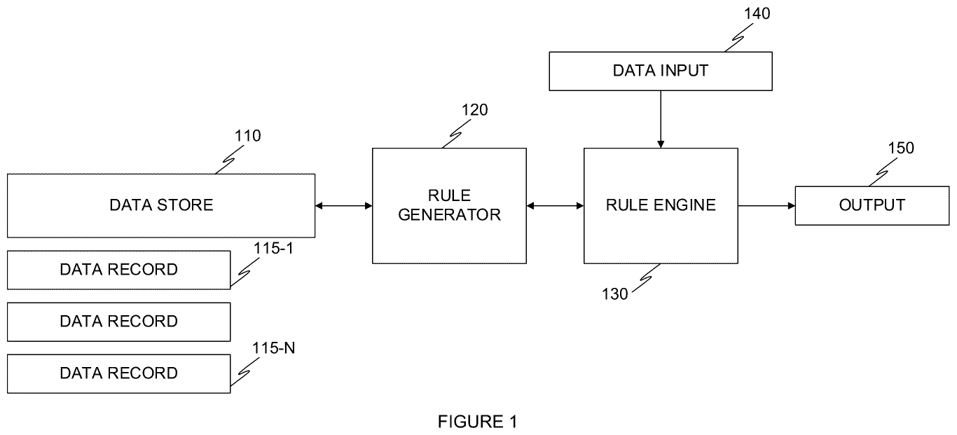

FIG. 1 is an example schematic diagram of a probabilistic rule engine system, implemented in accordance with an embodiment. In an embodiment, a data store 110 includes a plurality of data records 115-1 through 115-N, where ‘N’ is an integer having a value of ‘2’ or greater, referenced individually as data record 115 and collectively as data records 115.

In an embodiment, the data store is implemented as a database, such as a column-oriented database, including a table, a plurality of tables, etc. In some embodiments, the data store includes access to a storage, such as a bucket, in which the data records 115 are stored, for example in a cloud computing environment.

According to an embodiment, each data record 115 of the plurality of data records includes a data input and an output generated based on the data input. In some embodiments, the data input includes a plurality of values, such as a numerical value, a text value, a combination thereof, and the like.

In certain embodiments, the data input is a vector, including a plurality of data fields, each data field including a data value. In an embodiment, a portion of data fields include a value, and another portion of data fields do not include a value, include a value indicating that no value is present, etc.

In an embodiment, a rule generator 120, discussed in more detail herein, is configured to access the data store 110, and access the data records 115 stored therein. In certain embodiments, the rule generator 120 is configured to generate a plurality of rules, conditional statements, policies, a combination thereof, and the like. In an embodiment, a rule includes a condition. For example, according to an embodiment, a condition is an “IF” statement, such that if a condition of the rule is satisfied, a first action is initiated in a computing environment, and where the condition of the rule is not satisfied, a second action is initiated.

In some embodiments, a rule is generated utilizing a Boolean logic expression. In an embodiment, a rule utilizing Boolean logic includes a logical operator. According to some embodiments, a rule is generated to use Boolean logic (Boolean algebra), elementary algebra, a combination thereof, and the like.

In an embodiment, the rule generator 120 is configured to correlate values of data fields, for example based on a plurality of outputs, each associated with a data record. In some embodiments, the rule generator 120 includes a language model, such as a large language model (LLM), which is fine-tuned to generate a rule based on a prompt.

In certain embodiments, the language model includes an input layer which is configured to receive a context. In an embodiment, a plurality of data records 115 are provided as a context for the language model. In some embodiments, the language model is provided with a prompt which when processed by the language model outputs a rule for a rule engine 130.

According to an embodiment, the rule generator 120 is configured to generate a plurality of rules, utilizing a single, or multiple, rule generation techniques. In an embodiment, a rule engine 130 is configured to apply a rule on a data input 140.

In some embodiments, the rule engine 130 is configured to apply a plurality of rules on the data input 140. In certain embodiments, the rule engine 130 is a probabilistic rule engine (PRE) which is configured to assign a weight to each of the plurality of rules. In an embodiment, the rule engine 130 is configured to apply a generated rule, a preexisting rule, a combination thereof, and the like.

In some embodiments, the rule engine 130 is configured to assign a weight to each rule of the plurality of rules. In certain embodiments, the rule engine 130 is configured to assign weights based on a rule type (e.g., a generated rule, a preexisting rule, etc.). In an embodiment, the weight is a numerical value, such as a floating point value.

In an embodiment, the rule engine 130 is configured to apply a rule by applying a condition of a rule on a value, a plurality of values, and the like, associated with an input. For example, in an embodiment, the rule engine 130 is configured to perform a check based on a value of an input and a predetermined value of a rule.

According to an embodiment, the rule engine 130 is configured to apply a plurality of rules, each rule assigned a weight, to data input 140. In an embodiment, the rule engine 130 is configured to generate an output 150 based on a result, a plurality of results, and the like, of applying each rule of the plurality of rules on the data input 140.

For example, in an embodiment, a first rule having a first weight is applied to a first value of a first data field of the data input 140. In some embodiments, a second rule having a second weight value is applied to a second value of a second data field of the data input 140. In certain embodiments, a third rule having a third weight value is applied to the first value and the second value. In an embodiment, applying each rule generates a result.

In certain embodiments, an output 150 is generated by the rule engine 130, which is configured to generate the output 150 based on a plurality of results, each result assigned a weight of a corresponding rule.

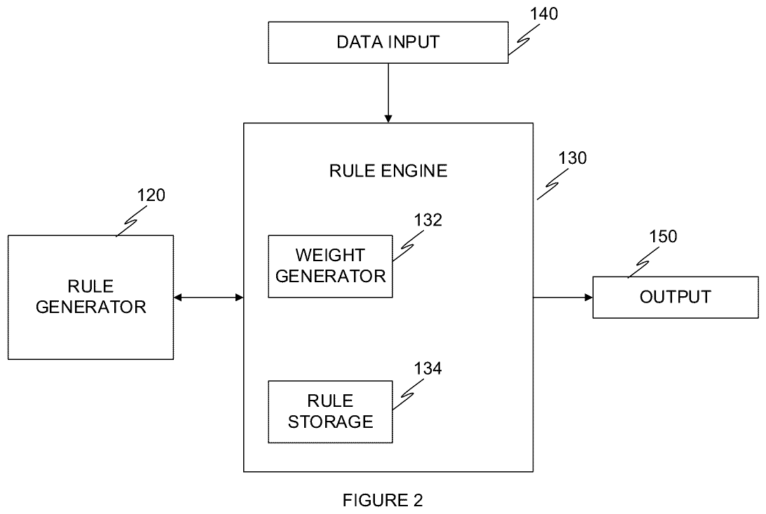

FIG. 2 is an example schematic diagram of a rule engine 130 utilizing a probabilistic rule application, utilized to describe an embodiment. According to an embodiment, the rule engine 130 includes a weight generator 132 and a rule storage 134.

In an embodiment, the rule engine 130 is implemented as a software application on a virtual machine. In some embodiments, the weight generator 132, the rule storage 134, and the like, are implemented as a software application module.

In an embodiment, a weight generator 132 is configured to assign a weight to a rule of the rule engine 130. For example, in an embodiment, the rule engine 130 is configured to store a plurality of rules on rule storage 134. In an embodiment, the rule storage 134 is configured to store a plurality of generated rules, a plurality of preexisting rules, a combination thereof, and the like.

In certain embodiments, the weight generator 132 is configured to assign a weight to a rule of a plurality of rules stored in the storage 134. In an embodiment, the weight generator 132 is further configured to adjust a weight of a rule, for example based on a target function. In some embodiments, the target function generates a value (i.e., an error value) based on a value of an output 150. In certain embodiments, the weight generator 132 is configured to minimize the error value, for example by adjusting a weight value associated with a rule, adjusting a plurality of weight values, adjusting a weight value a plurality of times, etc.

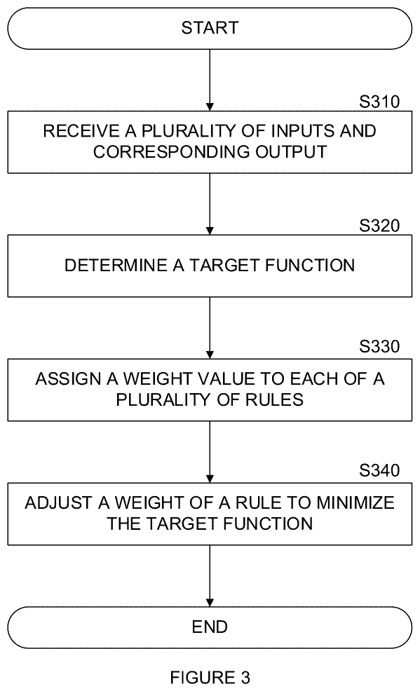

FIG. 3 is an example flowchart of a method for initializing a probabilistic rule engine, implemented in accordance with an embodiment. According to an embodiment, a probabilistic rule engine employs a rule engine having a plurality of rules, each rule assigned a weight. In an embodiment, each rule is expressed exclusively utilizing Boolean logic operators.

At S310, a plurality of data records is received. In an embodiment, a data record includes a data input and a corresponding data output. In some embodiments, the data output is generated based on a result of applying a rule on the data input. For example, in an embodiment, the data output is generated based on applying a plurality of rules on a data input, each rule associated with an assigned weight.

In an embodiment, a data record includes a data input, for example stored as a vector of values. In some embodiments, the values are text values, numerical values, alphanumerical values, Boolean values (i.e., ‘true’, ‘false’ or a representation thereof), a combination thereof, and the like.

At S320, a target function is determined. In an embodiment, a target function (also referred to as objective function) value is determined, e.g., an error value. In some embodiments, it is advantageous to minimize the error value in order to increase accuracy of outputs of the rule engine.

In some embodiments, the target function values are generated based on outputs of the plurality of data records. For example, in an embodiment, a target function error value is selected such that when each rule of the rule engine is applied to each of the data inputs, a ratio between a first output value and a second output value is less than a predetermined threshold value.

At S330, a weight is assigned to each rule. In an embodiment, a weight is assigned to each rule of a plurality of rules. In some embodiments, the plurality of rules includes generated rules, preexisting rules, a combination thereof, and the like.

According to an embodiment, an initial assignment of a weight value is performed based on a random assignment of values, based on a pseudo-random assignment of values, based on a number of data records determined relevant to the rule, a combination thereof, and the like.

In some embodiments, once a weight is assigned to each rule of the plurality of rules of the rule engine, a first training epoch is initialized. In an embodiment, a training epoch includes providing the rule engine with a plurality of data inputs, each data input having a corresponding desired output.

In certain embodiments, each rule is applied to each data input to generate a plurality of results per each rule. For each rule, an output is generated based on the plurality of results. An error value of the objective function is determined, based on the plurality of results, the output, the desired output, a comparison between an output and a desired output, a combination thereof, and the like. In an embodiment, the rule engine is configured to determine, based on the resulting error value, if another epoch should be initiated.

At S340, a weight is adjusted. In an embodiment, adjusting a weight value includes storing, associating, etc., a new value in place of a previous weight value associated with a rule. In some embodiments, a plurality of weight values, each corresponding to a rule of the plurality of rules of the rule engine, are updated, adjusted, etc.

In some embodiments, a weight value is adjusted prior to initializing a training epoch. For example, in an embodiment, a weight value of a rule is adjusted, and a second training epoch is initiated.

In certain embodiments, a training epoch is initiated until an error value of an objective function is below a predetermined threshold value. In some embodiments, a training epoch involves applying a plurality of rules to each of a plurality of data inputs. In an embodiment, applying a plurality of rules to each of a plurality of data inputs generates a plurality of results, each plurality of results corresponding to a data input of the plurality of data inputs.

According to an embodiment, an output is generated based on the plurality of results of each of the data inputs. In an embodiment, the output is compared to a desired output associated with the data input. In certain embodiments, an error value of an objective function is determined based on the comparison. Once an error value is determined, according to an embodiment, the epoch is complete.

In some embodiments, a plurality of epochs is initiated. In an embodiment, after each training epoch, a determined error value is compared to a threshold value. In certain embodiments, a probabilistic rule engine is a trained probability rule engine once the error value is determined to be less than the threshold value. In an embodiment, once the error value is below the threshold value, epoch initiation is terminated.

In an embodiment, an error value of a current epoch is compared to an error value of a previous epoch. In some embodiments, where the error value of the previous epoch is smaller than the error value of the current epoch, the rule engine is configured to initiate a remediation action. For example, in an embodiment, a remediation action includes terminating training of the rule engine based on the data inputs. In some embodiments, the remediation action includes accessing a larger number of data inputs, and initiating training epochs based on the larger number of data inputs.

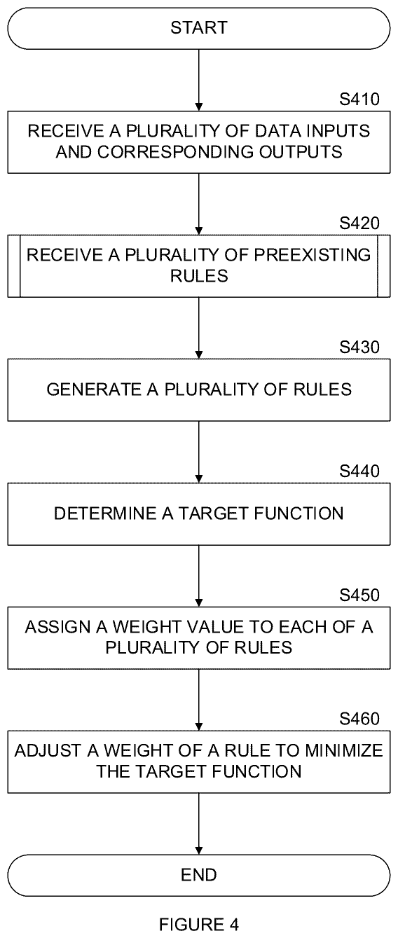

FIG. 4 is an example flowchart of a method for initializing a probabilistic rule engine utilizing preexisting and generated rules, implemented in accordance with an embodiment. In an embodiment, a rule engine includes a plurality of rules. In some embodiments, a first portion of rules of the plurality of rules are preexisting rules, and a second portion of rules of the plurality rules are generated rules.

In an embodiment, it is advantageous to utilize different types of rules, as it reduces the need to manually determine which rules are relevant and which are not. This can be cumbersome for sophisticated rule engines which have hundreds or thousands of rules.

At S410, a plurality of data records is received. In an embodiment, a data record includes a data input and a corresponding data output. In some embodiments, the data output is generated based on a result of applying a rule on the data input. For example, in an embodiment, the data output is generated based on applying a plurality of rules on a data input, each rule associated with an assigned weight.

In an embodiment, a data record includes a data input, for example stored as a vector of values. In some embodiments, the values are text values, numerical values, alphanumerical values, Boolean values (i.e., ‘true’, ‘false’ or a representation thereof), a combination thereof, and the like.

At optional S420, a plurality of preexisting rules is received. In an embodiment, a preexisting rule is a rule which is not assigned a weight, and utilized by a rule engine which is a classical rule engine, i.e., not a probabilistic rule engine.

In an embodiment, a rule includes a Boolean logic logical operator. According to some embodiments, a rule is generated to include Boolean logic (Boolean algebra), elementary algebra, a combination thereof, and the like.

In some embodiments, where a plurality of preexisting rules is not received, the rule engine is configured to generate rules, for example utilizing the techniques discussed in more detail throughout.

At S430, a plurality of rules is generated. In some embodiments, S430 is optional, for example where a plurality of preexisting rules is received. In an embodiment, the plurality of rules is generated by a rule engine, for example based on a plurality of data records.

In an embodiment, a data record includes a data input and an output. In some embodiments, the output is a desired output. In some embodiments, the data records are provided to a language model which is configured to receive a prompt. In an embodiment, the prompt includes a plurality of data records and a predetermined prompt template, which when processed by the language model, configures the language model to output a rule, a plurality of rules, etc.

In some embodiments, different techniques for generating rules are utilized. In certain embodiments, a rule is selected for storage in the rule engine in response to determining that the rule was generated using a first technique and was also generated using a second technique.

In certain embodiments, the first plurality of rules is generated prior to receiving a second plurality of rules. In some embodiments, a first plurality of rules is generated after receiving a second plurality of rules.

At S440, a target function is determined. In an embodiment, a target function (also referred to as objective function) value is determined, e.g., an error value. In some embodiments, it is advantageous to minimize the error value in order to increase accuracy of outputs of the rule engine.

In some embodiments, the target function values are generated based on outputs of the plurality of data records. For example, in an embodiment, a target function error value is selected such that when each rule of the rule engine is applied to each of the data inputs, a ratio between a first output value and a second output value is less than a predetermined threshold value.

At S450, a weight is assigned to each rule. In an embodiment, a weight is assigned to each rule of a plurality of rules. In some embodiments, the plurality of rules includes generated rules, preexisting rules, a combination thereof, and the like. In an embodiment, a first weight value range is assigned to a first type of rule (e.g., preexisting rules), and a second weight value range is assigned to a second type of rule (e.g., generated rules).

According to an embodiment, an initial assignment of a weight value is performed based on a random assignment of values, based on a pseudo-random assignment of values, based on a number of data records determined relevant to the rule, a combination thereof, and the like.

In some embodiments, once a weight is assigned to each rule of the plurality of rules of the rule engine, a first training epoch is initialized. In an embodiment, a training epoch includes providing the rule engine with a plurality of data inputs, each data input having a corresponding desired output.

In certain embodiments, each rule is applied to each data input to generate a plurality of results per each rule. For each rule, an output is generated based on the plurality of results. An error value of the objective function is determined, based on the plurality of results, the output, the desired output, a comparison between an output and a desired output, a combination thereof, and the like. In an embodiment, the rule engine is configured to determine, based on the resulting error value, if another epoch should be initiated.

At S460, a weight is adjusted. In an embodiment, adjusting a weight value includes storing, associating, etc., a new value in place of a previous weight value associated with a rule. In some embodiments, a plurality of weight values, each corresponding to a rule of the plurality of rules of the rule engine, are updated, adjusted, etc.

In some embodiments, a weight value is adjusted prior to initializing a training epoch. For example, in an embodiment, a weight value of a rule is adjusted, and a second training epoch is initiated.

In certain embodiments, a training epoch is initiated until an error value of an objective function is below a predetermined threshold value. In some embodiments, a training epoch involves applying a plurality of rules to each of a plurality of data inputs. In an embodiment, applying a plurality of rules to each of a plurality of data inputs generates a plurality of results, each plurality of results corresponding to a data input of the plurality of data inputs.

According to an embodiment, an output is generated based on the plurality of results of each of the data inputs. In an embodiment, the output is compared to a desired output associated with the data input. In certain embodiments, an error value of an objective function is determined based on the comparison. Once an error value is determined, according to an embodiment, the epoch is complete.

In some embodiments, a plurality of epochs is initiated. In an embodiment, after each training epoch, a determined error value is compared to a threshold value. In certain embodiments, a probabilistic rule engine is a trained probability rule engine once the error value is determined to be less than the threshold value. In an embodiment, once the error value is below the threshold value, epoch initiation is terminated.

In an embodiment, an error value of a current epoch is compared to an error value of a previous epoch. In some embodiments, where the error value of the previous epoch is smaller than the error value of the current epoch, the rule engine is configured to initiate a remediation action. For example, in an embodiment, a remediation action includes terminating training of the rule engine based on the data inputs. In some embodiments, the remediation action includes accessing a larger number of data inputs, and initiating training epochs based on the larger number of data inputs.

In some embodiments, a subset of the weights is adjusted. In an embodiment, a portion of rules includes a fixed weight rule (i.e., a non-adjustable weight) while other rules include adjustable weight rules. In certain embodiments, an input is received to indicate that a rule weight is fixed, adjustable, etc.

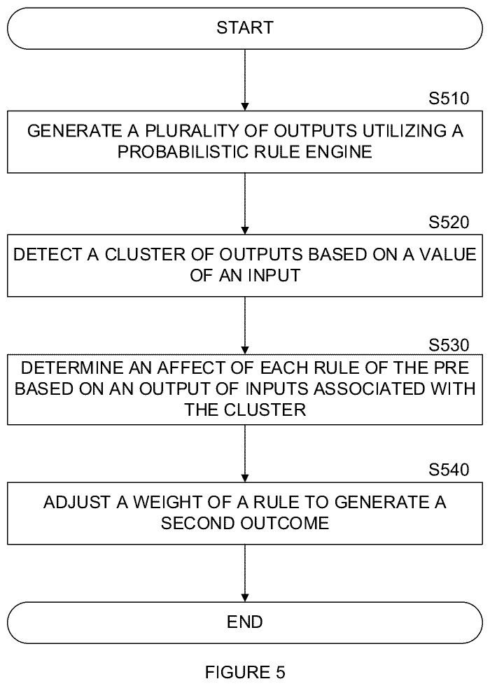

FIG. 5 is an example flowchart of a method for determining an effect of a rule on an output of a probabilistic rule engine, implemented in accordance with an embodiment. In some embodiments, it is advantageous to ascertain which rules of a probabilistic rule engine affect the ultimate output (e.g., the output based on the plurality of results of applying each rule on a data input).

At S510, a plurality of outputs is generated. In an embodiment, the plurality of outputs are generated each based on a data input. In some embodiments, a data input is received, and each rule of a plurality of rules of a probabilistic rule engine is applied to the data input.

In certain embodiments, each rule applied to the data input generates a result. For example, in an embodiment, a result is ‘true’, ‘false’, ‘0’, ‘1’, etc. In an embodiment, each result is associated with a weight value, corresponding to a weight value of the rule.

According to some embodiments, the output is generated based on a plurality of results, each result corresponding to an application of a rule of a plurality of rules on a data input.

At S520, a cluster is detected. In an embodiment, a cluster of data records is detected. According to an embodiment, a data record includes a data input and a corresponding output. In an embodiment, a cluster is generated based on the data output and at least a value of a data field of the data record.

For example, in an embodiment, a cluster includes all data records having an output of a first value, and having a second value as a value of a data field of the third data field of the data input, e.g., having a common value for a corresponding data field of a data input.

In certain embodiments, various clustering techniques are utilized in order to generate clusters. In some embodiments, a number of predetermined clusters is determined to be detected. For example, in an embodiment, the probabilistic rule engine is configured to detect four clusters based on output values and at least one data field value.

In an embodiment, a cluster is defined by rules which are triggered by the data records. For example, in an embodiment, a cluster includes all data records which trigger a first rule, a second rule, etc. A data record triggers a rule where a rule condition is applied. For example, in an association rule, an “if” statement applies only on certain data records.

At S530, an effect is determined for each rule on the cluster. In an embodiment, determining an effect includes adjusting a weight value for each rule and generating an output for each data input of a data record which is associated with the data cluster.

In an embodiment, a rule which effects the data records of the cluster changes the output values based on a change of a weight of a rule. For example, a first rule having a first weight value is changed to having a second weight value. In an embodiment, where the output has not changed for the cluster, or not significantly changed (e.g., changed above a threshold value), the rule is determined to be ineffective for the cluster.

In some embodiments, a first rule having a first weight value is changed to having a second weight value, and output values for the cluster change above a predetermined threshold. In such an embodiment, the rule is determined to have an effect on the cluster.

In certain embodiments, it is advantageous to alter, adjust, and the like, certain weight values, in order to promote outputs (and therefore outcomes) for certain clusters. For example, in an embodiment, where the probabilistic rule engine is utilized as a risk decision engine, it can be advantageous to identify a cluster of data records which correspond to “risky” transactions, and promote outputs to test whether there is actual risk in allowing certain transaction to go through. To do this, it is required to have knowledge of which rule weights should be adjusted.

At S540, a weight of a rule is adjusted. In an embodiment, a plurality of weights, each corresponding to a rule, are adjusted. In some embodiments, a weight of a rule having an effect on the cluster of data records is adjusted. In some embodiments, the weight value is adjusted continuously. For example, in an embodiment, the weight value is adjusted, and data inputs of the cluster are processed by the probabilistic rule engine using the adjusted weight value.

In an embodiment, a second output is generated for each data input of the cluster based at least on the adjusted weight value. In an embodiment, an objective function is determined for the cluster, and an error value is generated based on the outputs and the second outputs. In an embodiment, where the error value is above a predetermined threshold, the weight of the rule is adjusted again, and the data inputs are processed by the probabilistic rule engine again. This process iterates, according to an embodiment, until the error value is below a predetermined threshold.

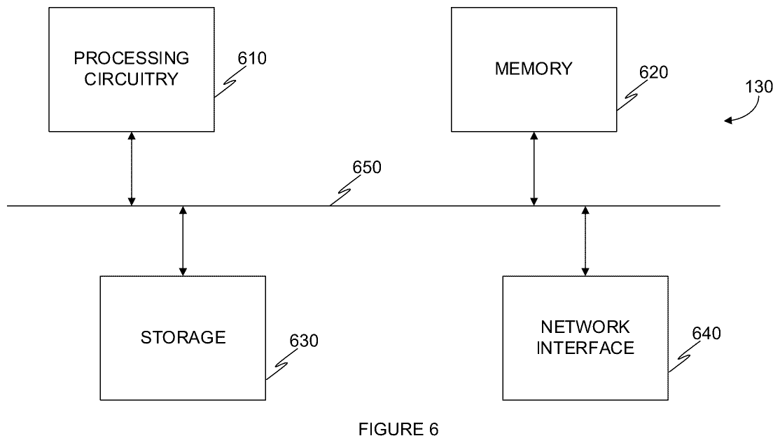

FIG. 6 is an example schematic diagram of a probabilistic rule engine 130 according to an embodiment. The probabilistic rule engine 130 includes, according to an embodiment, a processing circuitry 610 coupled to a memory 620, a storage 630, and a network interface 640. In an embodiment, the components of the probabilistic rule engine 130 are communicatively connected via a bus 650.

In certain embodiments, the processing circuitry 610 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information.

In an embodiment, the memory 620 is a volatile memory (e.g., random access memory, etc.), a non-volatile memory (e.g., read only memory, flash memory, etc.), a combination thereof, and the like. In some embodiments, the memory 620 is an on-chip memory, an off-chip memory, a combination thereof, and the like. In certain embodiments, the memory 620 is a scratch-pad memory for the processing circuitry 610.

In one configuration, software for implementing one or more embodiments disclosed herein is stored in the storage 630, in the memory 620, in a combination thereof, and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 610, cause the processing circuitry 610 to perform the various processes described herein, in accordance with an embodiment.

In some embodiments, the storage 630 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 640 is configured to provide the probabilistic rule engine 130 with communication with, for example, the rule generator 120, data store 110, a combination thereof, and the like, according to an embodiment.

It should be understood that the embodiments described herein are not limited to the specific architecture illustrated in FIG. 6, and other architectures may be equally used without departing from the scope of the disclosed embodiments.

Furthermore, in certain embodiments the probabilistic rule engine 130, the rule generator 120, the data store 110, a combination thereof, and the like, may be implemented with the architecture illustrated in FIG. 6. In other embodiments, other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for initiating a probabilistic rule engine and processing a data input, comprising:
receiving a plurality of data records, each data record including a data input and an output;
assigning a weight value to each rule of a plurality of rules, wherein the rules are implemented using at least a Boolean logic operator;
applying each rule of the plurality of rules to each data input of the plurality of data records to generate a plurality of results, each result corresponding to a rule of the plurality of rules;
generating for each data input a second output, based on the plurality of results corresponding to applying the plurality of rules on the data input;
determining an objective function of the probabilistic rule engine;
generating an error value based on each output of the plurality of data records and each second output;
adjusting a weight value of at least a first rule in response to determining that the error value is above a predetermined threshold; and
processing a new data input on the probabilistic rule engine, in response to determining that the error value is below the predetermined threshold.

2. The method of claim 1, further comprising:
adjusting the weight value in response to determining that the first rule is associated with an adjustable weight.

3. The method of claim 1, further comprising:
calibrating the probabilistic rule engine based on a first portion of the received plurality of data records.

4. The method of claim 3, wherein calibrating the probabilistic rule engine further comprises:
adjusting a weight value of a rule of the plurality of rules having an adjustable weight.

5. The method of claim 3, further comprising:
testing the probabilistic rule engine based on a second portion of the received plurality of data records.

6. The method of claim 5, further comprising:
processing a data record of the second portion of the received plurality of data records to generate a second output, wherein the data record includes a first output;
generating a difference value based on the first output and the second output; and
determining that the probabilistic rule engine is initialized in response to determining that the difference value is below a threshold.

7. The method of claim 1, wherein processing the new data input further comprises:
applying each rule of the plurality of rules on the new data input to generate an output.

8. The method of claim 7, further comprising:
determining that a rule of the plurality of rules is triggered in response to successfully applying the rule on the new data input.

9. The method of claim 1, wherein a rule of the plurality of rules includes any one of: an association rule, an algebraic rule, a conditional rule, and any combination thereof.

10. A non-transitory computer-readable medium storing a set of instructions for initiating a probabilistic rule engine and processing a data input, the set of instructions comprising:
one or more instructions that, when executed by one or more processors of a device, cause the device to:
receive a plurality of data records, each data record including a data input and an output;
assign a weight value to each rule of a plurality of rules, wherein the rules are implemented using at least a Boolean logic operator;
apply each rule of the plurality of rules to each data input of the plurality of data records to generate a plurality of results, each result corresponding to a rule of the plurality of rules;
generate for each data input a second output, based on the plurality of results corresponding to applying the plurality of rules on the data input;
determine an objective function of the probabilistic rule engine;
generate an error value based on each output of the plurality of data records and each second output;
adjust a weight value of at least a first rule in response to determining that the error value is above a predetermined threshold; and
process a new data input on the probabilistic rule engine, in response to determining that the error value is below the predetermined threshold.

11. A system for initiating a probabilistic rule engine and processing a data input comprising:
one or more processors configured to:
receive a plurality of data records, each data record including a data input and an output;
assign a weight value to each rule of a plurality of rules, wherein the rules are implemented using at least a Boolean logic operator;
apply each rule of the plurality of rules to each data input of the plurality of data records to generate a plurality of results, each result corresponding to a rule of the plurality of rules;
generate for each data input a second output, based on the plurality of results corresponding to applying the plurality of rules on the data input;
determine an objective function of the probabilistic rule engine;
generate an error value based on each output of the plurality of data records and each second output;
adjust a weight value of at least a first rule in response to determining that the error value is above a predetermined threshold; and
process a new data input on the probabilistic rule engine, in response to determining that the error value is below the predetermined threshold.

12. The system of claim 11, wherein the one or more processors are further configured to:
adjust the weight value in response to determining that the first rule is associated with an adjustable weight.

13. The system of claim 11, wherein the one or more processors are further configured to:
calibrate the probabilistic rule engine based on a first portion of the received plurality of data records.

14. The system of claim 13, wherein the one or more processors, when calibrating the probabilistic rule engine, are configured to:
adjust a weight value of a rule of the plurality of rules having an adjustable weight.

15. The system of claim 13, wherein the one or more processors are further configured to:
test the probabilistic rule engine based on a second portion of the received plurality of data records.

16. The system of claim 15, wherein the one or more processors are further configured to:
process a data record of the second portion of the received plurality of data records to generate a second output, wherein the data record includes a first output;
generate a difference value based on the first output and the second output; and
determine that the probabilistic rule engine is initialized in response to determining that the difference value is below a threshold.

17. The system of claim 11, wherein the one or more processors, when processing the new data input, are configured to:
apply each rule of the plurality of rules on the new data input to generate an output.

18. The system of claim 17, wherein the one or more processors are further configured to:
determine that a rule of the plurality of rules is triggered in response to successfully applying the rule on the new data input.

19. The system of claim 11, wherein a rule of the plurality of rules includes any one of:
an association rule, an algebraic rule, a conditional rule, and any combination thereof.
